(19) United States
(12) Patent Application Publication
(10) Pub. No.: US 2006/0219484 A1
(43) Pub. Date: Oct. 5, 2006

(54) Driving apparatus

(75) Inventor: Mitsuo Ogura, Nishikasugai-gun (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Nishikasugai-gun (JP)

(21) Appl. No.: 11/392,598

(22) Filed: Mar. 30, 2006

(30) Foreign Application Priority Data
Mar. 31, 2005 (JP) 2005-103322
Mar. 31, 2005 (JP) 2005-103291

(51) Int. Cl. F16H 25/00

(52) U.S. Cl. 185/39

(57) ABSTRACT

There is provided a driving apparatus which can automatically drive a functioning unit to cause the unit to operate as intended without using an on-board battery as a power supply therefor. The driving apparatus is installed in a vehicle to drive the functioning unit on the vehicle and includes an input unit which moves in response to acceleration resulting from a running operation of the vehicle or actions inevitably taken by an occupant when the occupant uses the vehicle and a driving unit which is connected to the input unit and the functioning unit and is adapted to follow the movement of the input unit to thereby accumulate therein a driving force, so as to drive the functioning unit with the driving force so accumulated.

This application is based on Japanese Patent Applications. No. 2005-103291 and 2005-103322, which are incorporated herein by reference.

### BACKGROUND OF THE INVENTION

1. Field of the Invention

The present invention relates to a driving apparatus installed in a vehicle for automatically driving a functioning unit to cause the unit to operate as intended.

2. Related Art

Although as a driving apparatus installed in a vehicle for automatically driving a functioning unit to cause the unit to operate as intended, a driving apparatus in which an electric motor is used as a driving source is generally used, using the driving apparatus in which an electric motor is used as a driving source results in a problem that a cost involved in circuit design is increased. In addition, a battery installed in the vehicle is generally used as a power supply for the electric motor. In recent years, however, the installation of an ECU and a navigation system in a vehicle is getting popular, and accordingly, the electric capacity of such a battery is required to be increased to an excessive level. Due to this, there has been a demand for a driving apparatus which can automatically drive a functioning unit to cause it to operate as intended without using the battery as a power supply therefor.

JP-A-7-296215 introduces a coin selecting machine utilizing vibration and oscillation which are produced by a vehicle. This coin selecting machine includes an inclined tray, a selector and stockers. Coins are caused to slide down on the inclined tray when they are subjected to vibration and oscillation produced by the vehicle to fall into the selector. In the selector, there are provided selection slots of different sizes which are formed in accordance with sizes of various coins, and the coins that have entered the selector then enter the selection slots corresponding thereto in size when being subjected to the vibration and oscillation produced by the vehicle. Lower ends of the respective selection slots connect to the different stockers, respectively. Consequently, the coins of different types that have fallen into the corresponding selection slots are selected accordingly.

The coin selecting machine introduced in JP-A-7-296215 is such as to select coins by virtue of vibration and oscillation produced by the vehicle but is not such as to drive another functioning unit. Namely, while there are raised as functioning units installed in a vehicle lids for opening and closing storage structures such as a console box, a glove box, a drink container holder and the like, the construction introduced in JP-A-7-296215 has a problem that the construction cannot drive these functioning units to cause the units to operate as intended. In addition, the coin selecting machine in JP-A-7-296215 can select coins only when the coins are subjected to vibration and oscillation produced by the vehicle. Namely, there has existed a problem that the functioning unit cannot be driven in such a state that the automobile stops running.

### SUMMARY OF THE INVENTION

The invention was made in view of the aforesaid situations and an object thereof is to provide a driving apparatus which can automatically drive a functioning unit to cause it to operate as intended.

According to a first aspect of the invention, there is provided a driving apparatus installed in a vehicle for driving a functioning unit, comprising an input unit adapted to move in response to acceleration resulting from a running operation of the vehicle and a driving unit connected to the input unit and the functioning unit and adapted to follow the movement of the input unit to thereby accumulate a driving force, so as to drive the functioning unit with the driving force so accumulated.

The driving apparatus of the invention preferably includes any of configurations that will be described below under (1) to (4).

(1) The running operation of the vehicle includes at least one of acceleration, deceleration, vibration and changing a direction of the vehicle.

(2) The driving unit includes a spring motor, and the spring motor is adapted to follow the movement of the input unit to thereby be wound, so as to accumulate therein the driving force.

(3) The input unit has a weight element and a pivotal support portion which pivotally supports the weight element, the weight element being adapted to oscillate by virtue of the running operation of the vehicle.

(4) The input unit has a weight element and an elastic member by which the weight element is suspended, the weight element being adapted to fluctuate vertically by virtue of the running operation of the vehicle.

In the driving apparatus according to the invention, the input unit moves in response to acceleration resulting from a running operation of the vehicle. Then, the driving unit follows the movement of the input unit to thereby accumulate therein the driving force, and the functioning unit is driven by the driving force so accumulated in the driving unit. Since the functioning unit is driven by the driving force that has been accumulated in advance, the functioning unit can be driven even when the input unit is not in operation. In addition, since the input unit moves in response to the acceleration resulting from the running operation of the vehicle, no battery is required for power supply therefor.

In the event that the driving apparatus of the invention includes the configuration described under (1), the driving force can be accumulated with good efficiency. Namely, while there are various types of running operations of the vehicle which generate acceleration, acceleration, deceleration, vibration and changing the direction of the vehicle are running operations of the vehicle which occur frequently. Due to this, in the event that the input unit is made to move by these running operations, the driving force can be accumulated with good efficiency.

In the event that the driving apparatus of the invention includes the configuration described under (2) the driving force can be manufactured at a low cost. Namely, while the driving unit may only have to include a known construction such as a spring motor, an electric motor and the like which can accumulate therein and release therefrom a driving force, in the event that the driving unit includes a spring motor, a complex circuit becomes unnecessary, thereby making it possible to reduce costs for materials involved in a required circuit.

In the event that the driving apparatus of the invention includes the configuration described under (3) or (4), the input unit can be configured by a simple construction, and even in the event that the running operation of the vehicle is relatively small, the input unit can be moved sufficiently.

According to a second aspect of the invention, there is provided a driving apparatus installed in a vehicle for driving a functioning unit, comprising an input unit adapted to move in response to actions of an occupant which are inevitable when he or she uses the vehicle and a driving unit connected to the input unit and the functioning unit and adapted to follow the movement of the input unit to thereby accumulate therein a driving force, so as to drive the functioning unit with the driving force so accumulated.

The driving apparatus of the invention preferably includes any of configurations that will be described below under (5) to (8).

(5) The operating frequency of the input unit is higher than the operating frequency of the functioning unit.

(6) The input unit is at least a device selected from a door, a window, a parking brake lever or pedal, a seat belt, a gearshift lever, a seat, a steering wheel, a service brake pedal and an accelerator pedal.

(7) The functioning unit is at least a device selected from a lid of a storage structure, a height adjusting device of the storage structure, a drawing device of the storage structure, a lid of a display structure, a fin of a register, a damper of the register, an adjusting device of a seat, and a load adjusting device of a steering wheel.

(8) The driving unit includes a spring motor, the spring motor being adapted to follow the movement of the input unit to thereby be wound, so as to accumulate therein the driving force.

In the driving apparatus according to the invention, the input unit moves in response to actions of an occupant which are inevitable when using the vehicle. Then, the driving unit follows the movement of the input unit to thereby accumulate therein the driving force, and the functioning unit is driven by the driving force so accumulated in the driving unit. Since the functioning unit is driven by the driving force that has been accumulated in advance, the functioning unit can be driven even when the input unit is not in operation. In addition, since the input unit is made to move in response to the actions of the occupant which are inevitable when using the vehicle, no battery is required for power supply therefor.

In the driving apparatus of the invention, in the event that the operating frequency of the input unit is higher than the operating frequency of the functioning unit, a sufficient driving force is accumulated in an operation of the functioning unit by virtue of the operation of the input unit by the occupant.

### BRIEF DESCRIPTION OF THE DRAWINGS

FIG. 1 is an enlarged explanatory drawing of a main part of a driving apparatus of Embodiment 1 which shows a state in which biasing force is accumulated in a driving unit;

FIG. 2 is an enlarged exploded perspective illustration of the main part which exemplarily shows the driving apparatus of Embodiment 1;

FIG. 3 is an enlarged explanatory drawing of the main part of the driving apparatus of Embodiment 1 which shows a state in which biasing force is accumulated in the driving unit;

FIG. 4 is an enlarged explanatory drawing of the main part of the driving apparatus of Embodiment 1 which shows a state in which a functioning unit is driven by biasing force accumulated in the driving unit;

FIG. 5 is an enlarged explanatory drawing of the main part of the driving apparatus of Embodiment 1 which shows a state in which the functioning unit is driven by biasing force accumulated in the driving unit;

FIG. 6 is an enlarged explanatory drawing of the main part of the driving apparatus of Embodiment 1 which shows a state in which the functioning unit is driven by biasing force accumulated in the driving unit;

FIG. 7 is an enlarged explanatory drawing of the main part of the driving apparatus of Embodiment 1 which shows a state in which the functioning unit is driven by biasing force accumulated in the driving unit;

FIG. 8 is an enlarged explanatory drawing of the main part of the driving apparatus of Embodiment 1 which shows a state in which the functioning unit is manually driven;

FIG. 9 is an enlarged explanatory drawing of the main part of the driving apparatus of Embodiment 1 which shows a state in which the functioning unit is manually driven;

FIG. 10 is an explanatory drawing of a driving apparatus of Embodiment 2 which exemplarily shows a state in which biasing force is accumulated in a spring motor;

FIG. 11 is an enlarged exploded perspective illustration of a main part of the driving apparatus of Embodiment 2 which exemplarily shows the same;

FIG. 12 is an explanatory drawing of the driving apparatus of Embodiment 2 which exemplarily shows a state in which biasing force is accumulated in the spring motor;

FIG. 13 is an overall drawing which exemplarily shows a driving apparatus of Embodiment 3;

FIG. 14 an enlarged exploded perspective illustration of a main part of the driving apparatus of Embodiment 3 which exemplarily shows the same;

FIG. 15 is an enlarged explanatory drawing of a main part of the driving apparatus of Embodiment 3 which shows a state in which biasing force is accumulated in a driving unit;

FIG. 16 is an enlarged explanatory drawing of the main part of the driving apparatus of Embodiment 3 which shows a state in which biasing force is accumulated in the driving unit;

FIG. 17 is an enlarged explanatory drawing of the main part of the driving apparatus of Embodiment 3 which shows a state in which a functioning unit is driven by biasing force accumulated in the driving unit;

FIG. 18 is an enlarged explanatory drawing of the main part of the driving apparatus of Embodiment 3 which shows a state in which the functioning unit is driven by biasing force accumulated in the driving unit;

FIG. 19 is an enlarged explanatory drawing of the main part of the driving apparatus of Embodiment 3 which shows a state in which the functioning unit is driven by biasing force accumulated in the driving unit;

FIG. 20 is an enlarged explanatory drawing of the main part of the driving apparatus of Embodiment 3 which shows a state in which the functioning unit is driven by biasing force accumulated in the driving unit;

FIG. 21 is an enlarged explanatory drawing of the main part of the driving apparatus of Embodiment 3 which shows a state in which the functioning unit is manually driven; and

FIG. 22 is an enlarged explanatory drawing of the main part of the driving apparatus of Embodiment 3 which shows a state in which the functioning unit is manually driven.

### DETAILED DESCRIPTION OF THE PREFERRED EMBODIMENTS

As a functioning unit which is driven by a driving apparatus of the invention, there is raised a lid which opens and closes a vehicle functioning device. For example, lids of a console box, a glove box, a container holder device, a monitor and a control panel of a navigation system, a display panel and a control panel of audio equipment and the like are raised as the functioning unit of the invention.

The movement of an input unit may be such as to correspond to a running operation of a vehicle, and various kinds of movements are raised which include vertical, horizontal, oscillating, rotating, sliding, turning and other movements.

Hereinafter, embodiments of driving apparatuses of the invention will be described based on the accompanying drawings.

### Embodiment 1

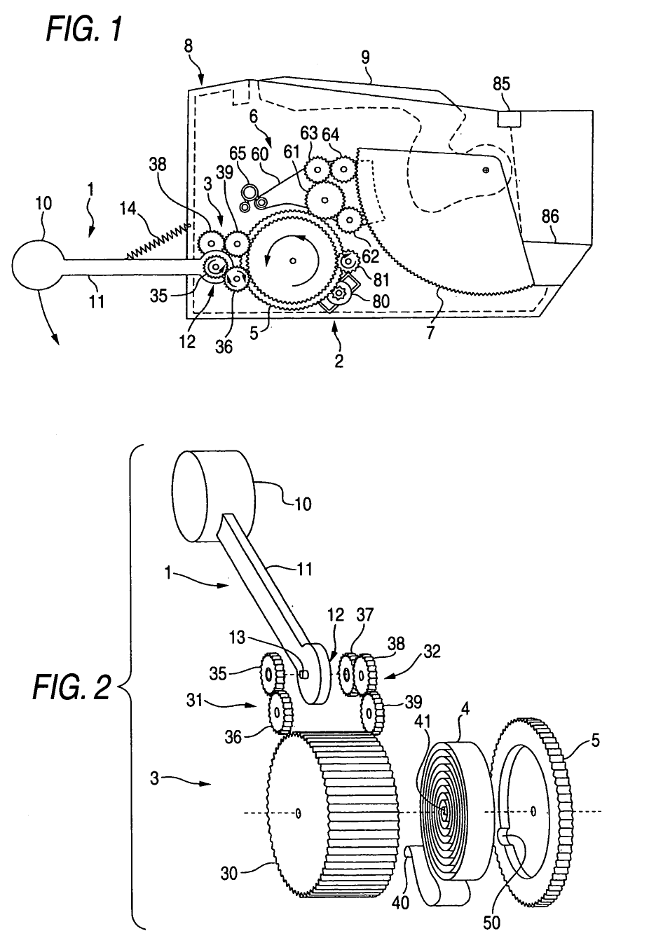

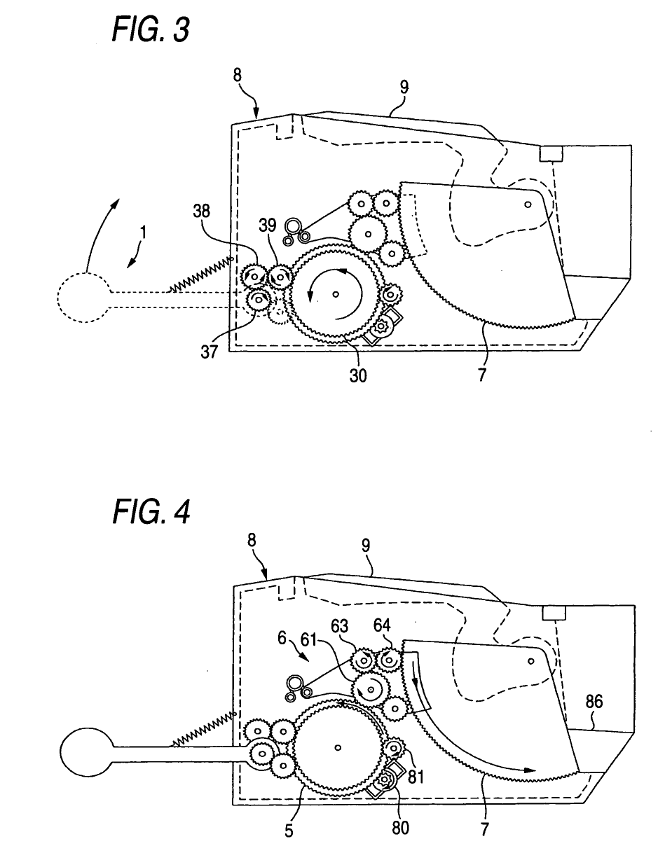

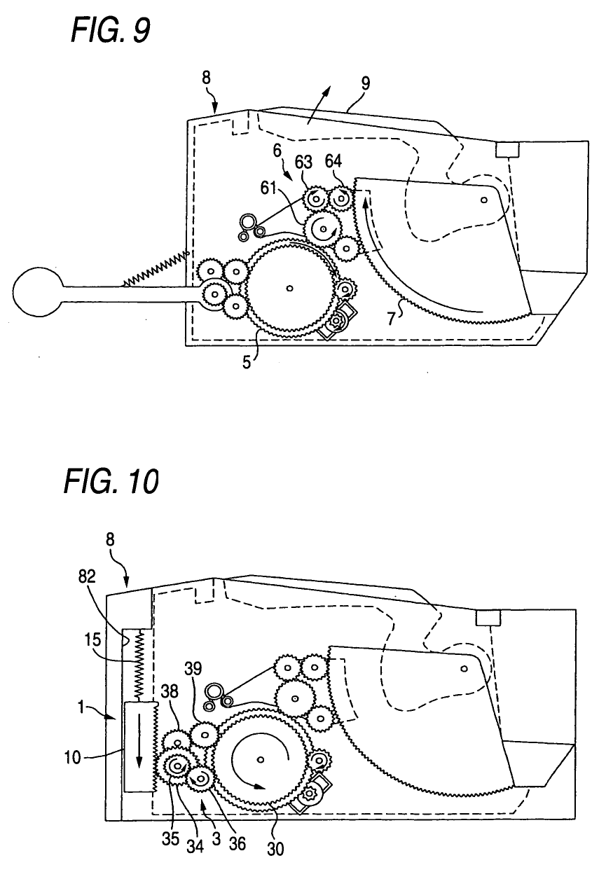

A driving apparatus of Embodiment 1 drives a lid of a console box installed in a vehicle to cause the lid to operate to open and close the console box. A functioning unit is the lid of the console box. The driving apparatus of Embodiment 1 is an example which includes the configurations described under (1), (2) and (3). Explanatory drawings which exemplarily show operations of the driving apparatus of Embodiment 1 are shown in FIGS. 1 and 3 to 9. Shown in FIG. 2 is an enlarged exploded perspective illustration of a main part of the driving apparatus 1 of Embodiment 1 which exemplarily shows the driving apparatus. FIGS. 1 and 3 are explanatory drawings of the main part of the driving apparatus which show respectively states in which biasing force is accumulated in a driving unit. FIGS. 4 to 7 are explanatory drawings of the main part of the driving apparatus which show respectively states in which the functioning unit is driven by biasing force accumulated in the driving unit. FIGS. 8 and 9 are explanatory drawings of the main part of the driving apparatus which show respectively states in which the functioning unit is manually driven. Hereinafter, when used in a description that will be developed below, “clockwise” and “counterclockwise” mean those as shown in FIG. 1.

The driving apparatus of Embodiment 1 has an input unit 1 and a driving unit 2. The input unit has, as shown in FIGS. 1 and 2, a weight element 10, a connecting rod 11 and a pivotal support shaft portion 12. A pivotal support portion is made up of the connecting rod 11 and the pivotal support shaft portion 12. The connecting rod 11 is formed into a rod shape. One end of the connecting rod 11 is expanded so as to be formed into the weight element 10. The other end of the connecting rod 11 is formed into the pivotal support shaft portion 12. Projecting connecting shafts 13 are formed front and back sides of the pivotal support shaft portion 12, respectively. One of the connecting shafts 13 is attached to a side wall of a console box 8. The input unit 1 oscillates about the pivotal support shaft portion 12 in response to acceleration resulting from a running operation of a vehicle. One of an elastic element 14 made up of a coil spring is attached to the connecting rod 11. The other end of the elastic element 14 is attached to a side wall of an end portion of the console box 8. The elastic element 14 keeps the balance of the input unit 1. The input unit 1 oscillates in two directions, clockwise and counterclockwise, about the pivotal support shaft portion 12. The driving unit 2 is connected to the input unit 1.

The driving unit 2 has an input connecting member 3, a spring motor 4, a driving gear 5, a connecting gear member 6 and a follower gear 7.

As shown in FIG. 2, the spring motor 4 exhibits the shape of a spiral spring which is made up of an elongate sheet metal wound counterclockwise. The spring motor 4 is received in the interior of a hollow portion defined between a driving gear 5 and a winding gear 30. The driving gear 5 is formed into a box shape. The winding gear 30 is formed into a box shape and is disposed concentrically with the driving gear 5 with an inner surface of the box-shaped winding gear 30 made to face an inner surface of the box-shaped driving gear 5. An inner end 41 of the spring motor 4 is fixed to the winding gear 30. The spring motor 4, the driving gear 5 and the winding gear 30 form a so-called barrel construction. A portion of the spring motor 4 which lies near an outer end 40 thereof is wound reversely into an S-shape. In addition, the outer end 40 is bent outwards. The outer end 40 is brought into press contact with a recessed portion 50 formed in an inner circumferential surface of the driving gear 5. When the spring motor 4 is wound, an external shape thereof shrinks, and a pressure with which the outer end 40 presses against a surface of the recessed portion 50 is reduced. When the spring motor 4 is wound excessively, the pressure exerted by the outer end 40 becomes too small, and the outer end 40 slides on the surface of the recessed portion 50, whereby an excessive load is prevented from being exerted on the spring motor 4 even when the spring motor 4 is so wound.

The driving gear 5 and the winding gear 30 are rotatably supported on the side wall of the console box 8. An oil damper 80 is connected to the driving gear 5. A reversing stop gear 81 made up of a one-way clutch is connected to the winding gear 30.

An input connecting member 3 is made up of a lower moving transmission portion 31, an upper moving transmission portion 32 and the winding gear 30. As shown in FIG. 2, the lower moving transmission portion 31 includes two gears, and the upper moving transmission gear 32 includes three gears. A lower moving transmission gear 35, which is one of the two gears of the lower moving transmission portion 31, is made up of a one-way clutch. The lower moving transmission gear 35 is connected to one of the connecting shafts 13 of the pivotal support shaft portion 12. Then, a counterclockwise oscillation of the input unit 1 is transmitted, whereas a clockwise oscillation thereof is cut off, whereby as shown in FIG. 1, when the input unit 1 oscillates counterclockwise, the lower moving transmission gear 35 rotates counterclockwise. When the input unit oscillates clockwise, the lower moving transmission gear 35 does not rotate. A lower moving link gear 36, which is the other gear of the lower moving transmission portion 31, meshes with the lower moving transmission gear 35. When the lower moving transmission gear 35 rotates counterclockwise, the lower moving link gear 36 rotates clockwise. The lower linking connecting gear 36 meshes with the winding gear 30. When the lower moving link gear 36 rotates clockwise, the winding gear 30 rotates counterclockwise. Namely, when the input unit 1 oscillates counterclockwise, the lower moving transmission gear 35 rotates counterclockwise, and the lower moving link gear 36 rotates clockwise, whereby the winding gear 30 rotates counterclockwise to thereby wind the spring motor 4.

An upper moving transmission gear 37, which is one of the three gears of the upper moving transmission portion 32, is made up of a one-way clutch. The upper moving transmission gear 37 is connected to the other connecting shaft 13 of the pivotal support shaft portion 12. Then, a clockwise oscillation of the input unit 1 is transmitted, whereas a counterclockwise oscillation thereof is cut off, whereby as shown in FIG. 3, when the input unit 1 oscillates clockwise, the upper moving transmission gear 37 rotates clockwise. When the input unit 1 oscillates counterclockwise, the upper moving transmission gear 37 does not rotate. An upper moving first link gear 38, which is the second gear of the upper moving transmission portion 32, rotates counterclockwise when the upper moving transmission gear 37 rotates clockwise. The upper moving first link gear 38 meshes with an upper moving second link gear 39, which is the third gear of the upper moving transmission portion 32. When the upper moving first link gear 38 rotates counterclockwise, the upper moving second link gear 39 rotates clockwise. The upper moving second link gear 39 meshes with the winding gear 30. When the upper moving second link gear 39 rotates clockwise, the winding gear 30 rotates counterclockwise. Namely, when the input unit 1 oscillates clockwise, the upper moving transmission gear 37 rotates clockwise, and the upper moving first link gear 38 rotates counterclockwise, the upper moving second link gear 39 rotating clockwise, whereby the winding gear 30 rotates counterclockwise to thereby wind the spring motor 4.

A functioning unit 9 opens and closes an opening which is formed in an upper surface of a main body of the console box 8. The functioning unit 9 is pivotally supported on the side walls of the console box 8 in such a manner as to rotate relative to the console box 8. A follower gear 7 is formed into the shape of a fan and is connected concentrically with the functioning unit 9. The functioning unit 9 rotates both clockwise and counterclockwise.

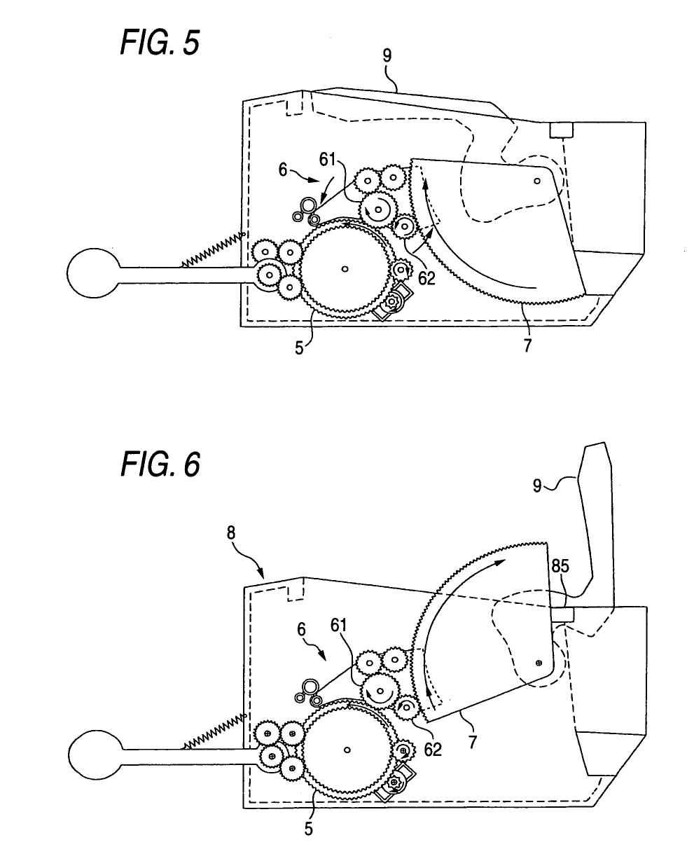

A connecting gear member 6 has a flat plate-shaped support plate 60, a first connecting gear 61, a second connecting gear 62, a third connecting gear 63 and a fourth connecting gear 64. The first connecting gear 61, the second connecting gear 62, the third connecting gear 63 and the fourth connecting gear 64 are rotatably supported on the support plate 60. The support plate 60 is pivotally supported on the side wall of the console box 8. The first connecting gear 61 meshes with the driving gear 5. A rotary shaft of the first connecting gear 61 is coaxial with an oscillatory shaft of the support plate 60. The second connecting gear 62 meshes with the first connecting gear 61. The third connecting gear 63 meshes with the first connecting gear 61. The fourth connecting gear 64 meshes with the third connecting gear 63. The support plate 60 oscillates between a reverse connecting position (shown in FIGS. 1, 3, 4, 7 and 9) where the fourth connecting gear 64 meshes with the follower gear 7 and a normal connecting position (shown in FIGS. 5, 6 and 8) where the second connecting gear 62 meshes with the follower gear 7. One end of a turnover spring 65 is connected to the support plate 60. The other end of the turnover spring 65 is fixed to the side wall of the console box 8. By this configuration, the connecting gear member 6 is biased to the normal connecting position and the reverse connecting position by the turnover spring 65. A group of gears which is made up of the first connecting gear 61 and the second connecting gear 62 is referred to as a first group of connecting gears and a group of gears which is made up of the first connecting gear 61, the third connecting gear 63 and the fourth connecting gear 64 is referred to as a second group of connecting gears.

A switch unit, not shown, is connected to the connecting gear member 6. When the switch unit is operated to be switched on, the connecting gear member 6 oscillates to be disposed at the normal connecting position. In addition, when the switch unit is operated to be switched off, the connecting gear 6 oscillates to be disposed at the reverse connecting position.

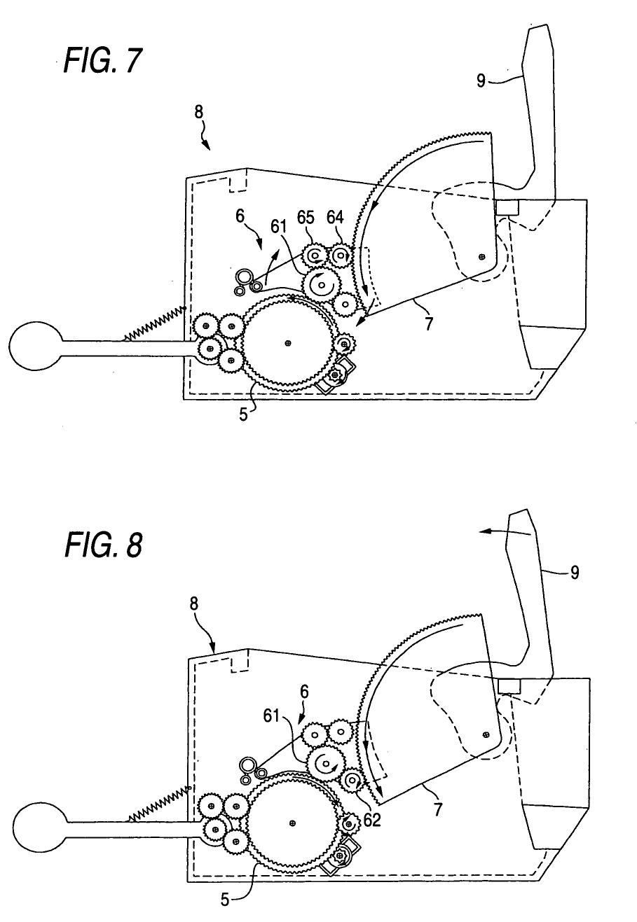

A first stopper 85 is formed at a position on the side wall of the console box 8 which is near the functioning unit 9 in such a manner as to project towards the follow gear 7. A second stopper 86 is formed at a position on the side wall of the console box 8 which is below the first stopper 85 in such a manner as to project towards the follower gear 7. The first stopper 85 is brought into engagement with the follower gear 7 when the functioning unit 9 is disposed at an opening position (shown in FIGS. 6 and 7) where it opens the opening of the console box 8. The second stopper 86 is brought into engagement with the follower gear 7 when the functioning unit 9 is disposed at a closing position (shown in FIGS. 1, 3, 4 and 5) where it closes the opening of the console box 8.

The operation of the driving apparatus of Embodiment 1 will be described below.

When biasing force is accumulated in the spring motor 4, the driving gear 5 rotates counterclockwise. As shown in FIG. 4, when the functioning unit 9 is disposed at the closing position with the connecting gear member 6 being disposed at the reverse connecting position, the driving gear 5 and the follower gear 7 are connected to each other via the second group of connecting gears. When the driving gear 5 rotates counterclockwise by virtue of the biasing force of the spring motor 4, the first connecting gear 61 rotates clockwise, and the third connecting gear 63 rotates counterclockwise, the fourth connecting gear 64 rotating clockwise, whereby the follower gear 7, which meshes with the fourth connecting gear 64, rotates counterclockwise. When the follower gear 7 rotates counterclockwise, the functioning unit 9, which is integrated into the follower gear 7, rotates counterclockwise so as to close the opening of the console box 8. When the functioning unit 9 rotates to the closing position, the follower gear 7 and the second stopper 86 are brought into engagement with each other, whereby the rotation of the follower gear 7 and the rotation of the functioning unit 9 are stopped.

Note that the reversing stop gear 81 is connected to the winding gear 30. Due to this, the winding gear 30 does not rotate clockwise. Consequently, the driving gear 5 is made to rotate counterclockwise by virtue of the biasing force of the spring motor 4. Furthermore, the oil damper 80 is connected to the driving gear 5. Due to this, the driving gear 5 rotates moderately, and the functioning unit 9 performs the opening and closing operations in a moderate fashion.

When the switch unit is operated to be switched on in a state shown in FIG. 4 (where the functioning unit 9 is disposed at the closing position and the connecting gear member 6 is disposed at the reverse connecting position), the connecting gear member 6 oscillates counterclockwise so as to be disposed at the normal connecting position. As this occurs, the driving gear 5 and the follower gear 7 are, as shown in FIG. 5, connected to each other via the first group of connecting gears. When the driving gear member 5 is made to rotate counterclockwise by virtue of the biasing force of the spring motor 4, the first connecting gear 61 rotates clockwise and the second connecting gear 62 rotates counterclockwise, as shown in FIG. 6, whereby the follower gear 7, which meshes with the second connecting gear 62, rotates clockwise. When the follower gear 7 rotates clockwise, the functioning unit 9 rotates clockwise so as to open the opening of the console box 8. When the functioning unit 9 rotates to the opening position, the follower gear 7 and the first stopper 85 are brought into engagement with each other, whereby the rotation of the follower gear 7 and the rotation of the functioning unit 9 are stopped.

When the switch unit is operated to be switched off in a state shown in FIG. 6 (where the functioning unit 9 is disposed at the opening position, and the connecting gear member 5 is disposed at the normal connecting position), the connecting gear member 6 oscillates clockwise to thereby be disposed at the reverse connecting position. As this occurs, the driving gear 5 and the follower gear 7 are, as shown in FIG. 7, connected to each other via the second group of connecting gears. When the driving gear 5 is made to rotate counterclockwise by virtue of the biasing force of the spring motor 4, the first connecting gear 61 rotates clockwise and the third connecting gear 63 rotates counterclockwise, as shown in FIG. 7, the fourth connecting gear 64 rotating clockwise, whereby the follower gear 7, which meshes with the fourth connecting gear 64, rotates counterclockwise. Then, the functioning unit 9 rotates counterclockwise so as to close the opening of the console box 8 (FIG. 4).

In the driving apparatus of Embodiment 1, the input unit 1 oscillates about the pivotal support shaft portion 12 in response to acceleration resulting from the running operation of the vehicle. For example, when the vehicle is accelerated, decelerated, vibrated or changes its direction, the input unit 1 oscillates in response to acceleration resulting from the running operation. Then, following the oscillation of the input unit 1, driving force is accumulated in the spring motor 4 of the driving unit 2, whereby the functioning unit 9 is driven by virtue of driving force so accumulated in the driving unit 2. Since the functioning unit 9 is driven by virtue of the driving force accumulated in advance, the functioning unit 9 can be driven even when the input unit 1 is not in operation. In addition, since the input unit 1 oscillates in response to acceleration resulting from the running operation of the vehicle, an on-board battery is not required for a power supply therefor.

In the driving apparatus of Embodiment 1, since the spring motor 4 is used as a drive source, a cost required for material is reduced, whereby the driving apparatus of Embodiment 1 can be manufactured inexpensively.

In addition, the connecting gear member 6 takes the two positions, the normal connecting position and the reverse connecting position. Due to this, the follower gear 7 can be made to rotate in both directions by the rotation of the driving gear 5 in one way, whereby the functioning unit 9 can be made to perform both the opening and closing operations by virtue of the biasing force of the spring motor 4.

On the other hand, when the functioning unit 9 is manually rotated counterclockwise in the state shown in FIG. 6 (where the functioning unit 9 is disposed at the opening position, and the connecting gear member 6 is disposed at the normal connecting position), the follower gear 7 rotates counterclockwise as shown in FIG. 8. Then, the second connecting gear 62, which meshes with the follower gear 7, rotates clockwise, and the first connecting gear 61 rotates counterclockwise. The driving gear 5, which meshes with the first connecting gear 61, rotates clockwise. Due to this, the spring motor 4 is wound, whereby biasing force is accumulated in the spring motor 4.

Furthermore, when the functioning unit 9 is manually rotated clockwise in the state shown in FIG. 4 (where the functioning unit 9 is disposed at the closing position and the connecting gear member 6 is disposed at the reverse connecting position), the follower gear 7 rotates clockwise as shown in FIG. 9. Then, the fourth connecting gear 64, which meshes with the follower gear 7, rotates counterclockwise, and the third connecting gear 63 rotates clockwise, the first connecting gear 61 rotating counterclockwise. The driving gear 5, which meshes with the first connecting gear 61, rotates clockwise. Due to this, also in this event, the spring motor 4 is wound, whereby biasing force is accumulated in the spring motor 4.

Thus, in the driving apparatus of Embodiment 1, the functioning unit 9 makes up a second input unit. Due to this, when the functioning unit 9 is manually operated so as to perform the opening or closing operation, the spring motor 4 is wound, so as to accumulate biasing force in the spring motor 4. In addition, the functioning unit 9 can automatically be made to perform the opening or closing operation by virtue of the biasing force that is accumulated in the spring motor 4 by manually operating the functioning unit 9 so as to perform the opening or closing operation.

In the driving apparatus of Embodiment 1, while the motion of the input unit 1 is transmitted to the driving unit 2 via the gears, another transmission means such as a wire may be used in place of the gears. For example, an end of a wire is fixed to the weight element 10 of the input unit 1 with the other end thereof fixed to a slidable rack, and the lower moving transmission gear 35 and the upper moving transmission gear 37 may be made to mesh with the rack. In this event, when the input unit 1 oscillates, the rack fixed to the wire slides, and the upper moving transmission gear 37 and the lower moving transmission gear 35, which mesh with the rack, rotate. Then, the winding gear 30 is made to rotate by virtue of rotations of the upper moving transmission gear 37 and the lower moving transmission gear 35, whereby the spring motor 4 can be wound.

In the driving apparatus of Embodiment 1, while the functioning unit 9 is driven to rotate, the functioning unit 9 can be driven to move rectilinearly. For example, a rack is provided on the functioning unit 9 in such a manner as to mesh with the follower gear 7, whereby the rotation of the follower gear 7 can be converted into a linear motion, so that the functioning unit 9 can be driven to move rectilinearly.

In the driving apparatus of Embodiment 1, while the spring motor 4 is made to be wound by the motions of the input unit 1 in both the directions, the spring motor 4 may be wound by the motion thereof in one direction only. In this event, the input gear is made to be made up of a one-way clutch, and the input gear may be made to mesh directly with the winding gear 30.

In the driving apparatus of Embodiment 1, while the spiral spring is used as the spring motor 4, another type of spring motor such as of a coil spring may be used. An electric motor may be used in place of the spring motor. In this event, in case the input gear and the electric motor are connected together, as in the case with Embodiment 1, the electric motor can be rotated by virtue of the motion of the input unit 1. In addition, power can be generated by virtue of the rotation of the electric motor. In the event that an electrical energy storing unit such as a capacitor is connected to the electric motor, electricity generated by the electric motor can be stored. In the event that the electric motor and the driving gear 5 are connected to each other, the electric motor can be rotated by power so stored, so as to drive the functioning unit 9.

### Embodiment 2

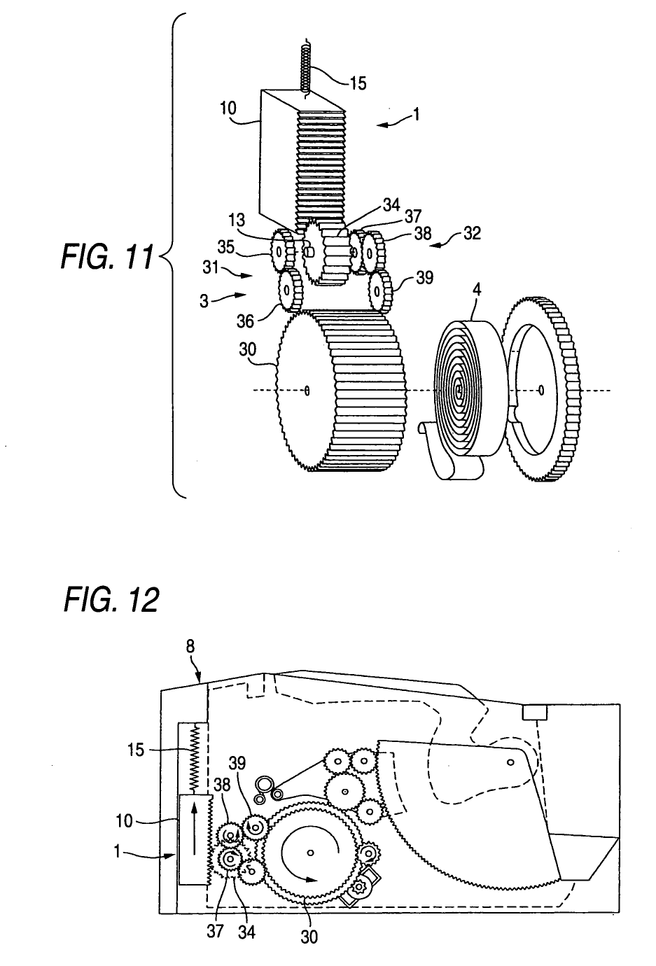

A driving apparatus of Embodiment 2 is an example which includes the configurations described under (1), (2) and (4). To be specific, the driving apparatus of Embodiment 2 is similar to that of Embodiment 1 except for an input unit and an input connecting member. In the driving apparatus of Embodiment 2, explanatory drawings which exemplarily show states in which biasing force is accumulated in a spring motor are shown in FIGS. 10 and 12. Shown in FIG. 11 is an enlarged exploded perspective illustration of a main part of the driving apparatus of Embodiment 2 which exemplarily shows the same driving apparatus. Hereinafter, when used in a description that will be developed below, “clockwise” and “counterclockwise” mean those as shown in FIG. 10.

As shown in FIGS. 10 and 11, an input unit 1 has a weight element 10 and an elastic member 15. The weight element 10 is formed into a prism shape and has a rack formed on one of sides thereof. The elastic member 15 made up of a coil spring is fixed to one longitudinal end portion of the weight element 10. The other end of the elastic member 15 is fixed to a side wall of an end portion of a console box 8. A vertically extending groove portion 82 is formed on the side wall of the end portion of the console box 8. The weight element 10 is disposed within the groove portion 82 with its longitudinal direction oriented in a vertical direction and is suspended by the elastic member 15. The input unit 1 fluctuates in response to acceleration resulting from a running operation of the vehicle. The groove portion 82 interferes with any other motions of the weight element 10 than the vertical motion thereof.

A connecting gear 34 is connected to the rack of the weight element 10. This connecting gear 34 meshes with the rack of the weight element 10 and is rotatably supported on the side wall of the console box 8. An axial center of the connecting gear 34 forms connecting shafts 13 which each extend in the form of a projection. In the driving apparatus of Embodiment 2, an input connecting member 3 is made up of the connecting gear 34, a lower moving transmission portion 31, an upper moving transmission portion 31 and a winding gear 30.

The lower moving transmission portion 31 is made up of two gears as in the case with Embodiment 1, and the upper moving transmission portion 32 is made up of three gears as in the case with Embodiment 1. A lower moving transmission gear 35, which is one of the gears of the lower moving transmission portion 31, is made up of a one-way clutch. The lower moving transmission gear 35 is connected to one of the connecting shafts 13 of the connecting gear 34. Then, a counterclockwise rotation of the connecting gear 34 is transmitted, whereas a clockwise rotation thereof is cut off, whereby as shown in FIG. 10, when the connecting gear 34 rotates counterclockwise, the lower moving transmission gear 35 rotates counterclockwise. The lower moving transmission gear 35 does not rotate when the connecting gear 34 rotates clockwise. A lower moving link gear 36, which is the other gear of the lower moving transmission portion 31, meshes with the lower moving transmission gear 35. When the lower moving transmission gear 35 rotates counterclockwise, the lower moving link gear 36 rotates clockwise. The lower moving link gear 36 meshes with the winding gear 30. When the lower moving link gear 36 rotates clockwise, the winding gear 30 rotates counterclockwise. Namely, when the input unit 1 moves in a downward direction, whereby the connecting gear 34 oscillates counterclockwise, the lower moving transmission gear 35 rotates counterclockwise, and the lower moving link gear 36 rotates clockwise, the winding gear 30 rotating counterclockwise so as to wind a spring motor 4.

An upper moving transmission gear 37, which is one of the gears of the upper moving transmission portion 32, is made up of a one-way clutch. The upper moving transmission gear 37 is connected to the other connecting shaft 13 of the connecting gear 34. Then, a clockwise rotation of the connecting gear 34 is transmitted, whereas a counterclockwise rotation thereof is cut off, whereby as shown in FIG. 12, when the connecting gear rotates clockwise, the upper moving transmission gear 37 rotates clockwise. When the connecting gear 34 rotates counterclockwise, the upper moving transmission gear 37 does not rotate. An upper moving first link gear 38, which is the second gear of the upper moving transmission portion 32, rotates counterclockwise when the upper moving transmission gear 37 rotates clockwise. The upper moving first link gear 38 meshes with an upper moving second link gear 39, which is the third gear of the upper moving transmission portion 32. When the upper moving first link gear 38 rotates counterclockwise, the upper moving second link gear 39 rotates clockwise. The upper moving second link gear 39 meshes with the winding gear 30. When the upper moving second link gear 39 rotates clockwise, the winding gear 30 rotates counterclockwise. Namely, when the input unit 1 moves in an upward direction, the connecting gear 34 rotates clockwise, the upper moving second link gear 39 rotates clockwise, the upper moving first link gear 38 rotates counterclockwise, and the upper moving second link gear 39 rotates clockwise, whereby the winding gear 30 rotates counterclockwise to thereby wind the spring motor 4.

In the driving apparatus of Embodiment 2, the input unit 1 fluctuates vertically in response to acceleration resulting from the running operation of the vehicle. Then, following the vertical fluctuation of the input unit 1, driving force is accumulated in the spring motor 4 of the driving unit 2, a functioning unit 9 is driven by virtue of driving force accumulated in the driving unit 2. In the driving apparatus of Embodiment 2, as with the driving apparatus of Embodiment 1, since the functioning unit 9 is driven by virtue of driving force that has been accumulated in advance, the functioning unit 9 can be driven even when the input unit 1 is not in operation. In addition, since the input unit 1 oscillates in response to acceleration resulting from the running operation of the vehicle, an on-board battery is not required for a power supply for the driving apparatus.

In the driving apparatus of Embodiment 2, since the spring motor 4 is used as the drive source, a cost required for material can be reduced. Consequently, as with the driving apparatus of Embodiment 1, the driving apparatus of Embodiment 2 can be manufactured inexpensively.

### Embodiment 3

While the embodiments have been described in which the input unit is utilized which is adapted to move in response to acceleration resulting from the running operation of the vehicle, an input unit can be used which is adapted to move in response to actions inevitably taken by an occupant when he or she uses a vehicle.

Note that the actions inevitably taken by the occupant when he or she uses a vehicle denote inevitable actions taken by the occupant when he or she gets in and out of the vehicle, inevitable actions taken by the occupant when he or she adjusts the vehicle, and inevitable actions taken by the occupant when he or she drives the vehicle. Raised as the inevitable actions taken by the occupant when he or she gets in and out of the vehicle are opening and closing operations of a door, a seating action taken when he or she is seated in the seat, a pulling operation of a seatbelt and the like. As this occurs, an input unit is the door, the seat and the seatbelt. Raised as the inevitable actions taken by the occupant when he or she adjusts the vehicle are opening and closing operations of a window and the like. As this occurs, the input unit is the window. Raised as the inevitable actions taken by the occupant when he or she drives the vehicle are turning operation of the steering wheel, on and off operations of the service brake pedal, on and off operations of the parking brake lever or pedal, on and off operations of the accelerator pedal, changing operation of the gearshift lever and the like. As these operations occur, the input unit is the steering wheel, the service brake pedal, the accelerator pedal, the parking brake lever or pedal and the gearshift lever. Note that while various devices can be used as the input unit, when an electrically powered device which is driven by a power supply from the on-board battery is used as the input unit, power needs to be increased to drive the electrically powered device. In addition, when the steering wheel, which is used to change the direction of the vehicle, is used as the input unit, load needs to be increased to operate the steering wheel.

Used preferably as a functioning unit are a lid of a storage structure, a height adjusting device of the storage structure, a drawing device of the storage structure, a lid of a display structure, a fin of a register, a damper of the register, a position adjusting device of a seat, a load adjusting device of a steering wheel and the like.

A structure for storing articles is raised as the storage structure. The storage structure includes, for example, a console box, a glove box, a drink container holder and the like. The lid of the storage structure denotes a lid which opens and closes the storage structure. The height adjusting device of the storage structure denotes an adjusting device which adjusts an interior height of the storage structure by raising and lowering a bottom plate of the storage structure. The drawing device of the storage structure which is made to be drawn out for deployment denotes a device which makes the storage structure slide in and out. Raised as the display structure are a monitor and a control panel of a navigation system and a display panel and a control panel of audio equipment and the like. The seat adjusting device denotes a device for adjusting the position, height and angle of the seat. The steering wheel load adjusting device denotes a device which supplies the steering wheel with a driving force so as to reduce a load required to operate the steering wheel (a so-called power steering system).

As a driving unit, for example, an electric motor and a spring motor may be provided which can store driving force therein, however, the spring motor is preferred to the electric motor. This is because as has been described above, the production cost of the driving apparatus is increased when the electric motor is used.

Hereinafter, Embodiment 3 of the invention will be described based on the accompanying drawings.

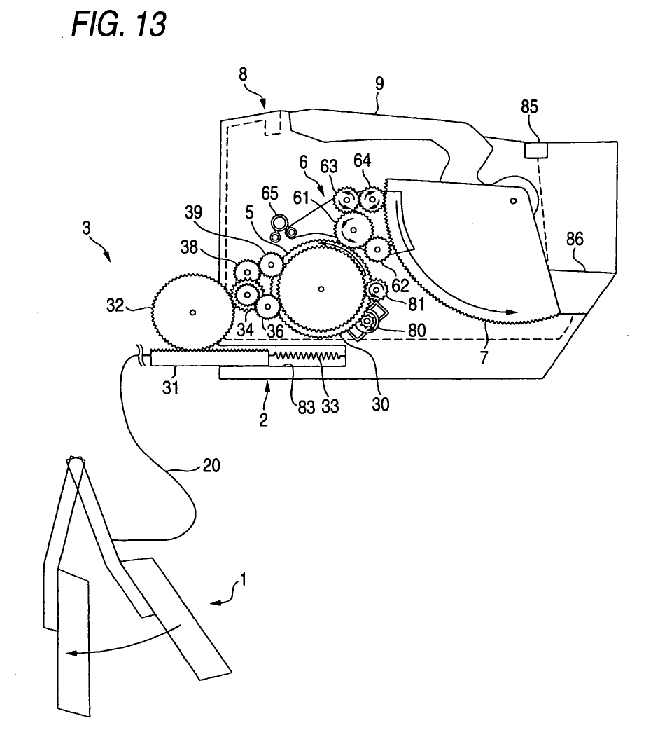

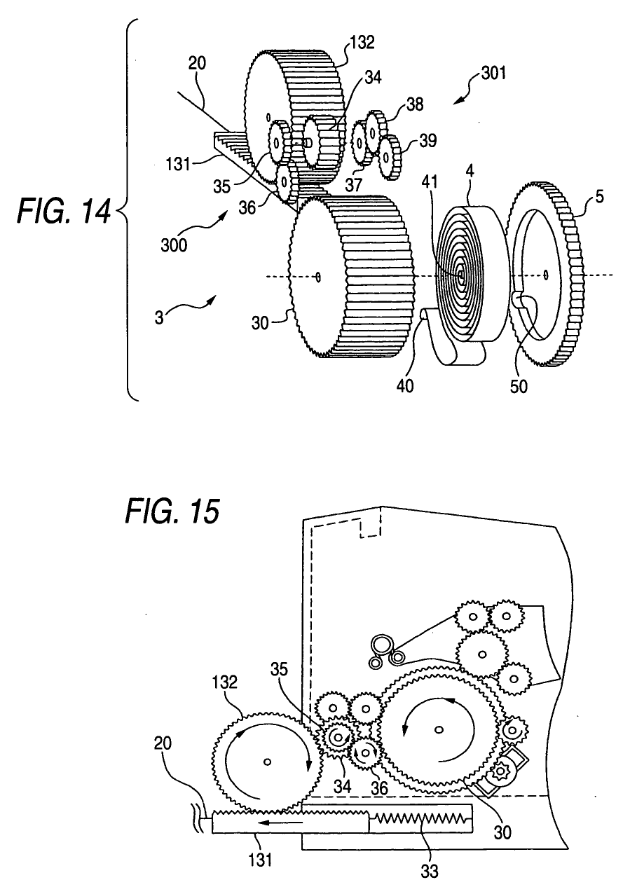

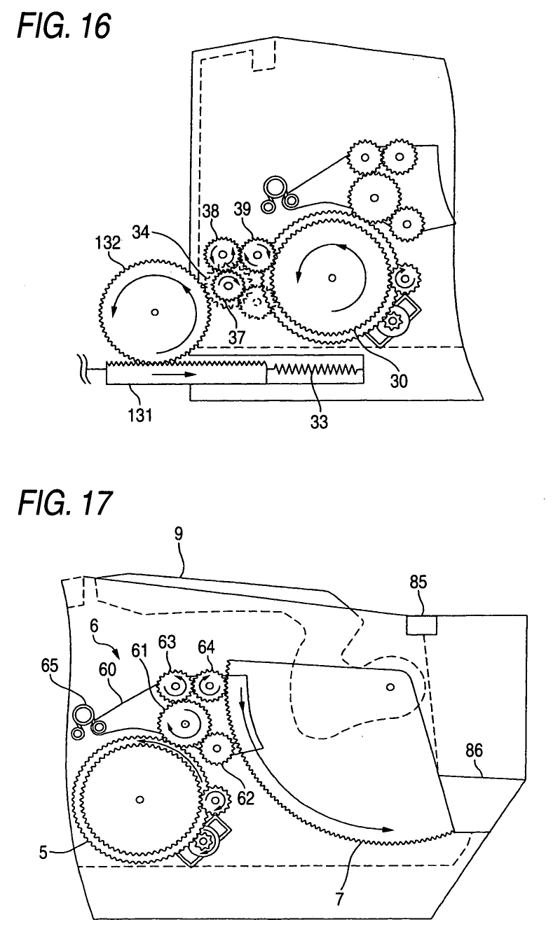

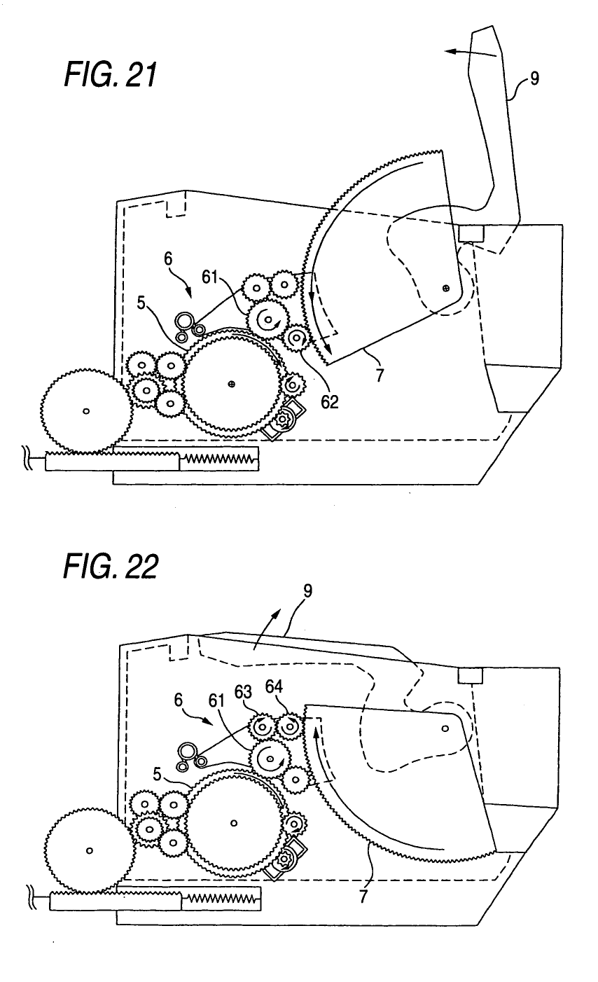

A driving apparatus of Embodiment 3 drives a lid of a console box installed in a vehicle to cause the lid to perform opening and closing operations. A functioning unit is the lid. An input unit is a parking brake pedal which is operated by the foot of the occupant. A driving unit includes a spring motor. Explanatory drawings which exemplarily show operations of the driving apparatus of Embodiment 3 are shown in FIGS. 13 and 15 to 22. An enlarged exploded perspective view of a main part of the driving apparatus of Embodiment 3 is shown in FIG. 14 which exemplarily shows the same apparatus. FIG. 13 is an overall drawing which exemplarily shows the driving apparatus of Embodiment 3. FIGS. 15 and 16 are enlarged explanatory drawings of the main part which show states in which biasing force is accumulated in a driving unit. FIGS. 17 to 20 are enlarged explanatory drawings of the main part which show states in which a functioning unit is driven by biasing force accumulated in the driving unit. FIGS. 21 and 22 are enlarged explanatory drawings of the main part which show states in which the functioning unit is manually driven. Hereinafter, when used in a description that will be developed below, “clockwise” and “counterclockwise” mean those as shown in FIG. 13.

The driving apparatus of Embodiment 3 has an input unit 1 and a driving unit 2. The input unit 1 oscillates when depressed by the occupant as shown in FIG. 13. One end of a wire 20, which constitutes part of the driving unit 2, is connected to the input unit 1. The wire 20 is pulled when the input unit 1 is oscillated. The other end of the wire 20 is connected to an input connecting member 3 which makes up part of the driving unit 2. The driving unit 2 has the input connecting member 3, a spring motor 4, a driving gear 5, a connecting gear member 6 and a follower gear 7.

As shown in FIG. 14, the spring motor 4 is made up of a spiral spring which is made up of an elongate sheet metal wound counterclockwise. The spring motor 4 is received in the interior of a hollow portion defined between a driving gear 5 and a winding gear 30. The driving gear 5 is formed into a box shape. The winding gear 30 is formed into a box shape and is disposed concentrically with the driving gear 5 with an inner surface of the box-shaped winding gear 30 made to face an inner surface of the box-shaped driving gear 5. An inner end 41 of the spring motor 4 is fixed to the winding gear 30. The spring motor 4, the driving gear 5 and the winding gear 30 form a so-called barrel construction. A portion of the spring motor 4 which lies near an outer end 40 thereof is wound reversely into an S-shape. In addition, the outer end 40 is bent outwards. The outer end 40 is brought into press contact with a recessed portion 50 formed in an inner circumferential surface of the driving gear 5. When the spring motor 4 is wound, an external shape thereof shrinks, and a pressure with which the outer end 40 presses against a surface of the recessed portion 50 is reduced. When the spring motor 4 is wound excessively, the pressure exerted by the outer end 40 becomes too small, and the outer end 40 slides on the surface of the recessed portion 50, whereby an excessive load is prevented from being exerted on the spring motor 4 even when the spring motor 4 is so wound.

The driving gear 5 and the winding gear 30 are rotatably supported on the side wall of the console box 8. An oil damper 80 is connected to the driving gear 5. A reversing stop gear 81 made up of a one-way clutch is connected to the winding gear 30.

The input connecting member 3 is made up of an input portion and a transmission portion. The input portion has a plate-shaped input rod 131 on which a rack is formed longitudinally and an input gear 132 which meshes with the rack on the input rod 131. The input rod 131 is received in an elongate groove 83 formed in a bottom wall of the console box 8 and is adapted to slide in and out of the elongate groove 83. The other end of the wire 20 is attached to one end of the input rod 131. One end of a biasing member 33 made up of a coil spring is attached to the other end of the input rod 131. The other end of the biasing member 33 is fixed to a groove wall of the elongate groove 83. The input gear 132 is rotatably supported on a side wall of an end portion of the console box 8.

When the input unit 1 is depressed, the wire 20 is pulled and the input rod 131 is pulled towards the left in FIG. 13. When the depression of the input unit 1 is released, the input rod 131 is pulled towards the right in FIG. 13 by virtue of biasing force of the biasing member 33.

As shown in FIG. 14, the transmission portion has an input transmission gear 34, a lower moving transmission portion 300 made up of two gears, an upper moving transmission portion 301 made up of three gears and a winding gear 30. The input transmission gear 34 is rotatably supported on the side wall of the console box 8 and meshes with the input gear 132. A lower moving transmission gear 35, which is one of the gears of the lower moving transmission portion 300, is made up of a one-way clutch. The lower moving transmission gear 35 is connected to the input transmission gear 34. Then, a counterclockwise rotation of the input transmission gear 34 is transmitted, whereas a clockwise rotation thereof is cut off, whereby as shown in FIG. 15, when the input transmission gear 34 rotates counterclockwise, the lower moving transmission gear 35 rotates counterclockwise. When the input transmission gear 34 rotates clockwise, the lower moving transmission gear 35 does not rotate. A lower moving link gear 36, which is the other gear of the lower moving transmission portion 300, meshes with the lower moving transmission gear 35. When the lower moving transmission gear 35 rotates counterclockwise, the lower moving link gear 36 rotates clockwise. The lower moving link gear 36 meshes with the winding gear 30. When the lower moving link gear 36 rotates clockwise, the winding gear 30 rotates counterclockwise. Namely, when the input unit 1 is depressed and the input rod 131 is pulled by the wire 20, the input gear 132 rotates clockwise, the input transmission gear 34 rotates counterclockwise, the lower moving transmission gear 35 rotates counterclockwise, and the lower moving link gear 36 rotates clockwise, whereby the winding gear 30 rotates counterclockwise to thereby wind the spring motor 4.

An upper moving transmission gear 37, which is one of the gears of the upper moving transmission portion 301, is made up of a one-way clutch. The upper moving transmission gear 37 is connected to the input transmission gear 34. Then, a clockwise rotation of the input transmission gear 34 is transmitted, whereas a counterclockwise rotation thereof is cut off, whereby as shown in FIG. 16, when the input transmission gear 34 rotates clockwise, the upper moving transmission gear 37 rotates counterclockwise. When the input transmission gear 34 rotates counterclockwise, the upper moving transmission gear 37 does not rotate. An upper moving first link gear 38, which is constituted by the second gear of the upper moving transmission portion 301, meshes with the upper moving transmission gear 37. The, when the upper transmission gear 37 rotates clockwise, the upper moving first link gear 38 rotates counterclockwise. The upper moving first link gear 38 meshes with an upper moving second link gear 39, which is the third gear of the upper moving transmission portion 301. When the upper moving first link gear 38 rotates counterclockwise, the upper moving second link gear 39 rotates clockwise. The upper moving second link gear 39 meshes with the winding gear 30. When the upper moving second link gear 39 rotates clockwise, the winding gear 30 rotates counterclockwise. Namely, when the depression of the input unit 1 is released and the input rod 131 is pulled by the biasing member 33, the input gear 132 rotates counterclockwise, the input transmission gear 34 rotates clockwise, the upper moving transmission gear 37 rotates clockwise, the upper moving first link gear 38 rotates counterclockwise, and the upper moving second link gear 39 rotates clockwise, whereby the winding gear 30 rotates counterclockwise to thereby wind the spring motor 4. When the spring motor 4 is wound, biasing force is accumulated in the spring motor 4. In Embodiment 3, the biasing force constitutes a driving force.

A functioning unit 9 opens and closes an opening formed in an upper surface of the console box 8. The functioning unit 9 is pivotally supported on the side walls of the console box 8 in such a manner as to rotate relative to the console box 8. The follower gear 7 is formed into the shape of a fan and is concentrically connected with the functioning unit 9. The functioning unit 9 rotates both clockwise and counterclockwise.

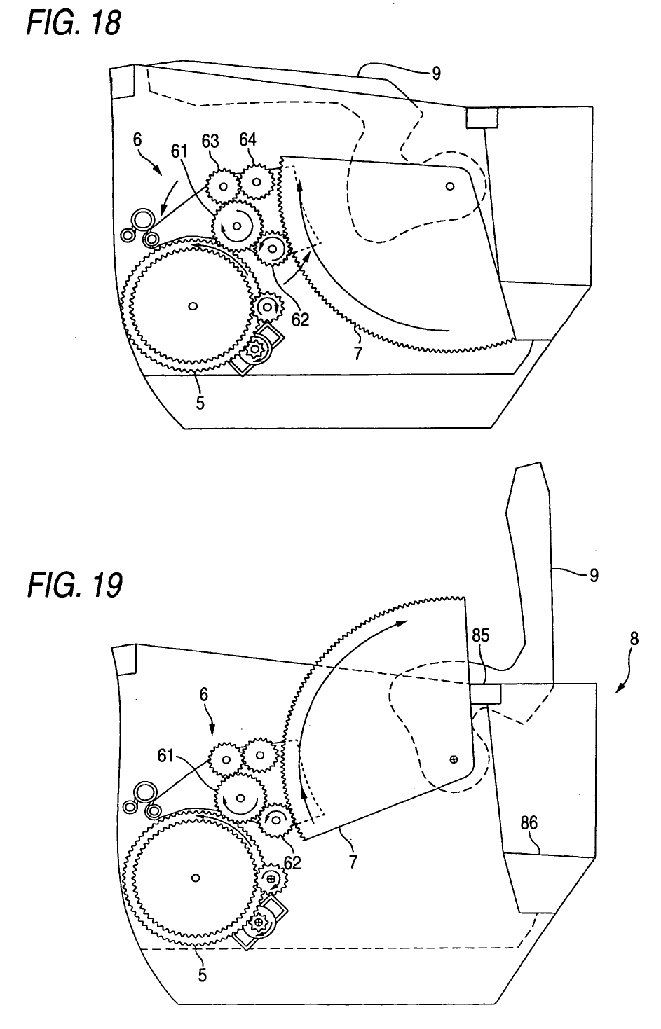

As shown in FIG. 17, the connecting gear member 6 has a flat plate-shaped support plate 60, a first connecting gear 61, a second connecting gear 62, a third connecting gear 63 and a fourth connecting gear 64. The first connecting gear 61, the second connecting gear 62, the third connecting gear 63 and the fourth connecting gear 64 are rotatably supported on the support plate 60. The support plate 60 is pivotally supported on the side wall of the console box 8. The first connecting gear 61 meshes with the driving gear 5. A rotary shaft of the first connecting gear 61 is coaxial with a rotary shaft of the support plate 60. The second connecting gear 62 meshes with the first connecting gear 61. The third connecting gear 63 meshes with the first connecting gear 61. The fourth connecting gear 64 meshes with the third connecting gear 63. The support plate 60 oscillates between a reverse connecting position (shown in FIGS. 13, 17, 20, and 22) where the fourth connecting gear 64 meshes with the follower gear 7 and a normal connecting position (shown in FIGS. 18, 19, and 21) where the second connecting gear 62 meshes with the follower gear 7. One end of a turnover spring 65 is connected to the support plate 60. The other end of the turnover spring 65 is fixed to the side wall of the console box 8. By this configuration, the connecting gear member 6 is biased to the normal connecting position and the reverse connecting position by the turnover spring 65. A group of gears which is made up of the first connecting gear 61 and the second connecting gear 62 is referred to as a first group of connecting gears and a group of gears which is made up of the first connecting gear 61, the third connecting gear 63 and the fourth connecting gear 64 is referred to as a second group of connecting gears.

A switch unit, not shown, is connected to the connecting gear member 6. When the switch unit is operated to be switched on, the connecting gear member 6 oscillates to be disposed at the normal connecting position. In addition, when the switch unit is operated to be switched off, the connecting gear 6 oscillates to be disposed at the reverse connecting position.

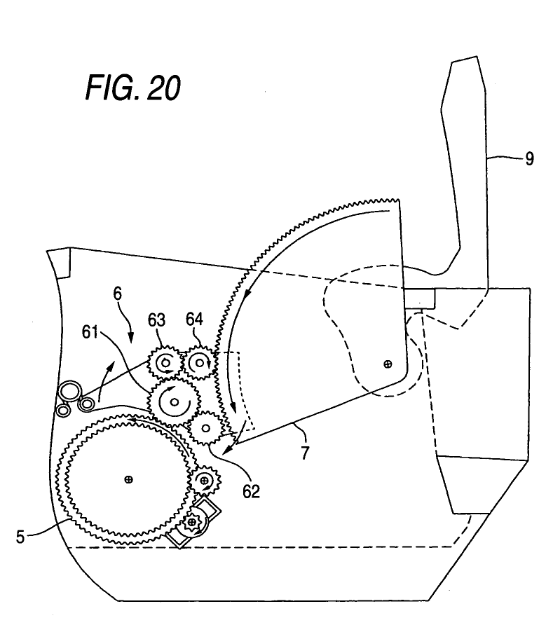

A first stopper 85 is formed at a position on the side wall of the console box 8 which is near the functioning unit 9 in such a manner as to project towards the follow gear 7. A second stopper 86 is formed at a position on the side wall of the console box 8 which is below the first stopper 85 in such a manner as to project towards the follower gear 7. The first stopper 85 is brought into engagement with the follower gear 7 when the functioning unit 9 is disposed at an opening position (shown in FIGS. 19 and 20) where it opens the opening of the console box 8. The second stopper 86 is brought into engagement with the follower gear 7 when the functioning unit 9 is disposed at a closing position (shown in FIGS. 17 and 18) where it closes the opening of the console box 8.

The operation of the driving apparatus of Embodiment 3 will be described below.

When biasing force is accumulated in the spring motor 4 by virtue of the movement of the input unit 1, the driving gear 5 rotates counterclockwise. As shown in FIG. 17, when the functioning unit 9 is disposed at the closing position with the connecting gear member 6 disposed at the reverse connecting position, the driving gear 5 and the follower gear 7 are connected to each other via the second group of connecting gears. When the driving gear rotates counterclockwise by the biasing force of the spring motor 4, the first connecting gear 61 rotates clockwise, and the third connecting gear 63 rotates counterclockwise, the fourth connecting gear 64 rotating clockwise, whereby the follower gear 7, which meshes with the fourth connecting gear 64, rotates counterclockwise. When the follower gear 7 rotates counterclockwise, the functioning unit 9, which is connected to the follower gear 7, rotates counterclockwise to thereby close the opening in the console box 8. When the functioning unit 9 rotates to the closing position, the follower gear 7 and the second stopper 86 are brought into engagement with each other, whereby the rotation of the follower gear 7 and the rotation of the functioning unit 9 are stopped.

Note that the reversing stop gear 81 is connected to the winding gear 30. Due to this, the winding gear 30 does not rotate clockwise. Consequently, the driving gear 5 rotates counterclockwise by the biasing force of the spring motor 4. Furthermore, the oil damper 80 is connected to the driving gear 5. Due to this, the driving gear 5 rotates moderately, and the functioning unit 9 performs the opening and closing operations moderately.

When the switch unit is operated to be switched on in a state (where the functioning unit 9 is disposed at the closing position and the connecting gear member 6 is disposed at the reverse connecting position) shown in FIG. 17, the connecting gear member 6 oscillates counterclockwise to thereby be disposed at the normal connecting position as shown in FIG. 18. As this occurs, the driving gear 5 and the follower gear 7 are connected to each other via the first group of connecting gears. When the driving gear 5 rotates counterclockwise by the biasing force of the spring motor 4, the first connecting gear 61 rotates clockwise and the second connecting gear 62 rotates counterclockwise, as shown in FIG. 19, whereby the follower gear 7, which meshes with the second connecting gear 62, rotates clockwise. When the follower gear 7 rotates clockwise, the functioning unit 9 rotates clockwise to thereby open the opening in the console box 8. When the functioning unit 9 rotates to the opening position, the follower gear 7 and the first stopper 85 are brought into engagement with each other, whereby the rotation of the follower gear 7 and the rotation of the functioning unit 9 are stopped.

When the switch unit is operated to be switched off in a state (where the functioning unit 9 is disposed at the opening position and the connecting gear member 6 is disposed at the normal connecting position) shown in FIG. 19, the connecting gear member 6 rotates clockwise to thereby be disposed to the reverse connecting position, as shown in FIG. 20. As this occurs, the driving gear 5 and the follower gear 7 are connected to each other via the second group of connecting gears. When the driving gear 5 rotates counterclockwise by the biasing force of the spring motor 4, the first connecting gear 61 rotates clockwise, and the third connecting gear 63 rotates counterclockwise, the fourth connecting gear 64 rotating clockwise, whereby the follower gear 7, which meshes with the fourth connecting gear 64, rotates counterclockwise. Then, the functioning unit 9 rotates counterclockwise to thereby close the console box 8 (FIG. 17).

In the driving apparatus of the embodiment, the input unit 1 oscillates by virtue of the inevitable actions taken by the occupant when he or she uses the vehicle, that is, due to the parking brake foot pedal, which constitutes the input unit 1, being depressed by the occupant. Then, following the oscillation of the input unit 1, driving force is accumulated in the spring motor 4, and the functioning unit 9 is driven by driving force accumulated in the driving unit 2. Since the functioning unit 9 is driven by the driving force that has been accumulated in advance, the functioning unit 9 can be driven even when the input unit 1 is not in operation. In addition, since the input unit 1 is operated by virtue of the inevitable actions taken by the occupant when he or she uses the vehicle, the on-board battery is not required to supply power to operate the input unit 1.

In the driving apparatus of the embodiment, since the spring motor 4 is used as a drive source, a cost required for material is reduced, whereby the driving apparatus of Embodiment 1 can be manufactured inexpensively.

In addition, the connecting gear member 6 takes the two positions, the normal connecting position and the reverse connecting position. Due to this, the follower gear 7 can be made to rotate in both directions by the rotation of the driving gear 5 in one way, whereby the functioning unit 9 can be made to perform both the opening and closing operations by virtue of the biasing force of the spring motor 4.

On the other hand, when the functioning unit 9 is manually rotated counterclockwise in the state shown in FIG. 19 (where the functioning unit 9 is disposed at the opening position, and the connecting gear member 6 is disposed at the normal connecting position), the follower gear 7 rotates counterclockwise as shown in FIG. 21. Then, the second connecting gear 62, which meshes with the follower gear 7, rotates clockwise, and the first connecting gear 61 rotates counterclockwise. The driving gear 5, which meshes with the first connecting gear 61, rotates clockwise. Due to this, the spring motor 4 is wound, whereby biasing force is accumulated in the spring motor 4.

Furthermore, when the functioning unit 9 is manually rotated clockwise in the state shown in FIG. 17 (where the functioning unit 9 is disposed at the closing position and the connecting gear member 6 is disposed at the reverse connecting position), the follower gear 7 rotates clockwise as shown in FIG. 22. Then, the fourth connecting gear 64, which meshes with the follower gear 7, rotates counterclockwise, and the third connecting gear 63 rotates clockwise, the first connecting gear 61 rotating counterclockwise. The driving gear 5, which meshes with the first connecting gear 61, rotates clockwise. Due to this, also in this event, the spring motor 4 is wound, whereby biasing force is accumulated in the spring motor 4.

Thus, in the driving apparatus of the embodiment, the functioning unit 9 makes up a second input unit. Due to this, when the functioning unit 9 is manually operated so as to perform the opening or closing operation, the spring motor 4 is wound, so as to accumulate biasing force in the spring motor 4. In addition, the functioning unit 9 can automatically be made to perform the opening or closing operation by virtue of the biasing force that is accumulated in the spring motor 4 by manually operating the functioning unit 9 so as to perform the opening or closing operation.

In the driving apparatus of Embodiment 3, while the movement of the input unit 1 is transmitted to the driving unit 2 via the wire 20, other devices such as gears may be used in place of the wire 20.

In the driving apparatus of Embodiment 3, while the functioning unit 9 is driven to rotate, the functioning unit 9 can be driven to move rectilinearly. For example, a rack is provided on the functioning unit 9 in such a manner as to mesh with the follower gear 7, whereby the rotation of the follower gear 7 can be converted into a linear motion, so that the functioning unit 9 can be driven to move rectilinearly.

In the driving apparatus of Embodiment 3, while the spring motor 4 is made to be wound by the motions of the input unit 1 in both the directions, the spring motor 4 may be wound by the motion thereof in one direction only. In this event, the input gear 132 is made to be made up of a one-way clutch, and the input gear 132 may be made to mesh directly with the winding gear 30.

In the driving apparatus of Embodiment 3, while the spiral spring is used as the spring motor 4, another type of spring motor such as of a coil spring may be used.

In the driving apparatus of Embodiment 3, while the parking brake foot pedal is used as the input unit 1 which oscillates by virtue of the actions of the occupant, even in the event that the gearshift lever, the door and the like are selected as the input unit 1, the functioning unit 9 can be driven through a similar mechanism to what has been described in this embodiment. In addition, a device which rotates or slides by virtue of the actions of the occupant can be selected as the input unit 1. For example, in the event that a window is selected as the input unit 1, the input gear 132 may be connected to a handle which is operated to open and close the window. In this event, the input gear 132 is made to rotate by virtue of the rotating operation of the handle, so that the spring motor 4 can be wound which is connected to the input unit 1 via the input gear 132. Alternatively, the wire 20 may be connected to the window. In this event, the wire 20 is pulled by virtue of a vertical movement of the window, so that the spring motor 4 can be wound which is connected to the input unit 1 via the wire 20, the input rod 131, the input gear 132 and the like. Furthermore, the input rod 131 may be connected to the window. In this event, the input gear 132 connected to the input rod 131 is made to rotate by virtue of the vertical movement of the window, so that the spring motor 4, which is connected to the input gear 132, can be wound.

In the event that a seatbelt is selected as the input unit 1, the input gear 132 maybe connected to the seatbelt so selected. In this event, the input gear 132 is made to rotate by operating the seatbelt to be deployed, so that the spring motor 4 can be wound which is connected to the input unit 1 via the input gear 132. Alternatively, the wire 20 may be connected to the seatbelt. In this event, the wire 20 is pulled by operating the seatbelt to be deployed, so that the spring motor 4 can be wound which is connected to the input unit 1 via the wire 20, the input rod 131, the input gear 132 and the like.

In the event that a seat is selected as the input unit 1, the input rod 131 may be provided on the seat so selected. In this event, the input gear 132, which is connected to the input rod 131, is made to rotate by virtue of a vertical movement of the seat that occurs when the occupant is seated in the seat, so that the spring motor 4 can be wound which is connected to the input gear 132. Alternatively, the wire 20 may be connected to the seat. In this event, the wire 20 is pulled by virtue of a vertical movement of the seat, so that the spring motor 4 can be wound which is connected to the input unit 1 via the wire 20, the input rod 131, the input gear 132 and the like. Alternatively, a fluid retaining device into and out of which fluid is allowed to flow through deformation thereof is provided underneath the seat and a turbine or the like may be provided which connects to the fluid retaining device and the input gear 132. In this event, the turbine or the like is made to turn by a fluid pressure generated by virtue of a vertical movement of the seat, whereby the input gear 132 connected to the turbine or the like is rotated so that the spring motor 4 can be wound which is connected to the input gear 132.

Thus, while the embodiments of the driving apparatuses of the invention have been described in detail, in the driving apparatuses of the invention, the mechanism which makes the driving unit 2 follow the movement of the input unit 1 is not limited to the mechanisms described in the embodiments. In addition, the mechanism which drives the functioning unit 9 by virtue of the driving force accumulated in the driving unit 2 is not limited to the mechanisms described in the embodiments. Additionally, it is obvious to those skilled in the art that various changes and modifications can be made to the invention without departing from the spirit and scope thereof.

What is claimed is:

1. A driving apparatus for driving a functioning unit, comprising:
an input unit adapted to move in response to acceleration resulting from a running operation of a vehicle; and
a driving unit connected to the input unit and the functioning unit and adapted to follow the movement of the input unit to thereby accumulate therein a driving force, so as to drive the functioning unit with the driving force so accumulated.

2. The driving apparatus according to claim 1, wherein the running operation of the vehicle includes at least one of acceleration, deceleration, vibration and changing a direction of the vehicle.

3. The driving apparatus according to claim 1, wherein the driving unit includes a spring motor, the spring motor being adapted to follow the movement of the input unit to thereby be wound, so as to accumulate therein the driving force.

4. The driving apparatus according to claim 1, wherein the input unit includes:
a weight element adapted to oscillate by virtue of the running operation the vehicle; and
a pivotal support portion which pivotally supports the weight element.

5. The driving apparatus according to claim 1, wherein the input unit includes:
a weight element adapted to fluctuate vertically by virtue of the running operation of the vehicle; and
an elastic member by which the weight element is suspended.

6. The driving apparatus according to claim 1, wherein the driving apparatus is installed in the vehicle.

7. A driving apparatus for driving a functioning unit, comprising:
an input unit adapted to move in response to an action of an occupant which is inevitable when the occupant uses a vehicle; and
a driving unit connected to the input unit and the functioning unit and adapted to follow the movement of the input unit to thereby accumulate therein a driving force, so as to drive the functioning unit with the driving force so accumulated.

8. The driving apparatus according to claim 7, wherein the operating frequency of the input unit is higher than the operating frequency of the functioning unit.

9. The driving apparatus according to claim 7, wherein the input unit is at least a device selected from a door, a window, a parking brake lever or pedal, a seat belt, a gearshift lever, a seat, a steering wheel, a service brake pedal and an accelerator pedal.

10. The driving apparatus according to claim 7, wherein the functioning unit is at least a device selected from a lid of a storage structure, a height adjusting device of the storage structure, a drawing device of the storage structure, a lid of a display structure, a fin of a register, a damper of the register, an adjusting device of a seat, and a load adjusting device of a steering wheel.

11. The driving apparatus according to claim 7, wherein the driving unit includes a spring motor, the spring motor being adapted to follow the movement of the input unit to thereby be wound, so as to accumulate therein the driving force.

12. The driving apparatus according to claim 7, wherein the driving apparatus is installed in the vehicle.
